(19) United States
(12) Patent Application Publication
(10) Pub. No.: US 2023/0153331 A1
(43) Pub. Date: May 18, 2023

(54) Entity Identity Matching

(71) Applicant: S&P Global Inc., New York, NY (US)

(72) Inventors: Ji Hua, Bala Cynwyd, PA (US); Evan Michael Fagerberg, Attleboro, MA (US); Jonathan Edward Hoyt Hayden, Westford, MA (US)

(21) Appl. No.: 17/455,629

(22) Filed: Nov. 18, 2021

(51) Int. Cl. G06F 16/28; G06N 20/20; G06Q 10/08

(52) U.S. Cl. CPC G06F 16/288; G06N 20/20; G06Q 10/087

(57) ABSTRACT

A computer-implemented method for entity resolution is provided. The method comprises receiving a number of different entity identifiers and grouping the entity identifiers into a number of entity pairs. The entity pairs are fed into a match generator filter that determines a similarity score for each entity pair according to a number of similarity algorithms. Potentially matching entity pairs comprising a subset of the entity pairs that have similarity scores above a first specified threshold are then fed into a machine learning model that determines a confidence score for each potentially matching entity pair. The machine learning model identifies matched entities that comprise a subset of the potentially matching entity pairs that have confidence scores above a second specified threshold.

### BACKGROUND INFORMATION

### 1. Field

The present disclosure relates generally to an improved computing system, and more specifically to a method of resolving entities within a supply chain database that refer to the same company.

### 2. Background

In supply chain databases it is common to have multiple entries for the same company. Such redundant entries may be the result of abbreviations, different naming or address conventions, or simple typographical errors made by different parties at different locations and times along the supply chain.

Therefore, it would be desirable to have a method and apparatus that take into account at least some of the issues discussed above, as well as other possible issues.

### SUMMARY

An illustrative embodiment provides a computer-implemented method for entity resolution. The method comprises receiving a number of different entity identifiers and grouping the entity identifiers into a number of entity pairs. The entity pairs are fed into a match generator filter that determines a similarity score for each entity pair according to a number of similarity algorithms. Potentially matching entity pairs comprising a subset of the entity pairs that have similarity scores above a first specified threshold are then fed into a machine learning model that determines a confidence score for each potentially matching entity pair. The machine learning model identifies matched entities that comprise a subset of the potentially matching entity pairs that have confidence scores above a second specified threshold.

Another illustrative embodiment provides a system for entity resolution. The system comprises a storage device configured to store program instructions and one or more processors operably connected to the storage device and configured to execute the program instructions to cause the system to: receive a number of different entity identifiers; group the entity identifiers into a number of entity pairs; feed the entity pairs into a match generator filter; determine, by the match generator filter, according to a number of similarity algorithms, a similarity score for each entity pair; feed potentially matching entity pairs into a machine learning model, wherein the potentially matching entity pairs comprise a subset of the entity pairs that have similarity scores above a first specified threshold; determine, by the machine learning model, a confidence score for each potentially matching entity pair; and identify, by the machine learning model, matched entities, wherein the matched entities comprise a subset of the potentially matching entity pairs that have confidence scores above a second specified threshold.

Another illustrative embodiment provides a computer program product for entity resolution. The computer program product comprises a computer-readable storage medium having program instructions embodied thereon to perform the steps of: receiving a number of different entity identifiers; grouping the entity identifiers into a number of entity pairs; feeding the entity pairs into a match generator filter; determining, by the match generator filter, according to a number of similarity algorithms, a similarity score for each entity pair; feeding potentially matching entity pairs into a machine learning model, wherein the potentially matching entity pairs comprise a subset of the entity pairs that have similarity scores above a first specified threshold; determining, by the machine learning model, a confidence score for each potentially matching entity pair; and identifying, by the machine learning model, matched entities, wherein the matched entities comprise a subset of the potentially matching entity pairs that have confidence scores above a second specified threshold.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 is a block diagram of an entity resolution system depicted in accordance with an illustrative embodiment;

FIG. 3 depicts a diagram illustrating the operation of the entity resolution system in accordance with an illustrative embodiment;

FIG. 4 depicts a diagram illustrating resolutions results between entity identifiers in accordance with an illustrative embodiment;

FIG. 5 depicts a diagram illustrating a visualization of forest view of a random forest model in accordance with an illustrative embodiment;

FIG. 6 depicts a diagram illustrating a visualization of a tree view of a random forest model in accordance with an illustrative embodiment;

FIG. 7 depicts a flowchart illustrating a process for entity resolution in accordance with an illustrative embodiment; and

FIG. 8 is a block diagram of a data processing system in accordance with an illustrative embodiment.

### DETAILED DESCRIPTION

The illustrative embodiments recognize and take into account one or more different considerations. The illustrative embodiments recognize and take into account that in supply chain databases it is common to have multiple entries for the same company.

The illustrative embodiments recognize and take into account that such redundant entries may be the result of abbreviations, different naming or address conventions, or simple typographical errors made by different parties at different locations and times along the supply chain.

The illustrative embodiments provide a method for resolving entities to determine when multiple entries within a database in fact refer to the same company. The illustrative embodiments group entity identifiers into pairs and compare the similarity of entities within each pair to identify potential matches. These potential matches are then classified by a machine learning model to identify matched pairs that comprise entities that refer to the same company.

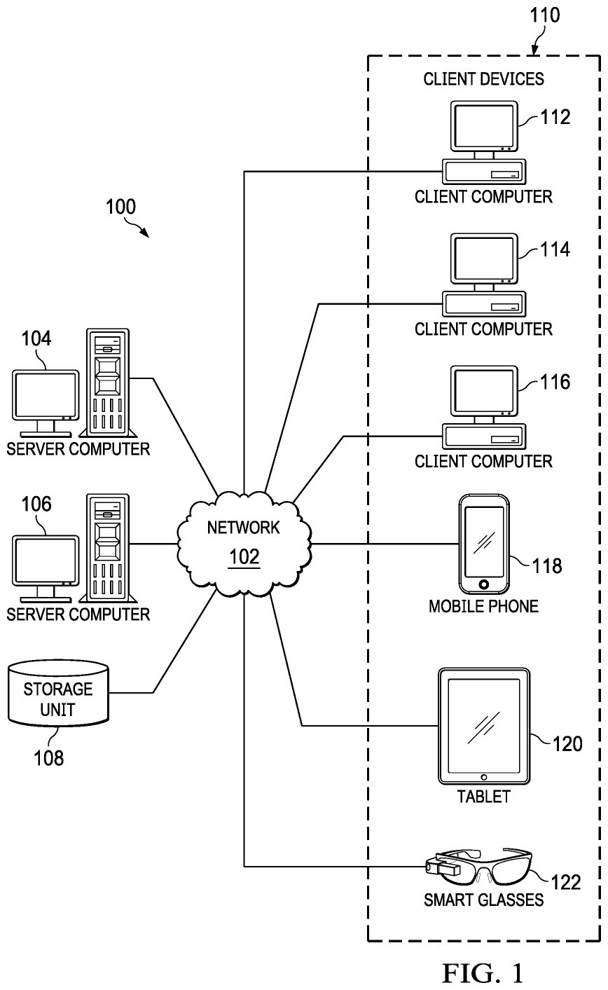

With reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 might include connections, such as wire, wireless communication links, or fiber optic cables.

In the depicted example, server computer 104 and server computer 106 connect to network 102 along with storage unit 108. In addition, client devices 110 connect to network 102. In the depicted example, server computer 104 provides information, such as boot files, operating system images, and applications to client devices 110. Client devices 110 can be, for example, computers, workstations, or network computers. As depicted, client devices 110 include client computers 112, 114, and 116. Client devices 110 can also include other types of client devices such as mobile phone 118, tablet computer 120, and smart glasses 122.

In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, the program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

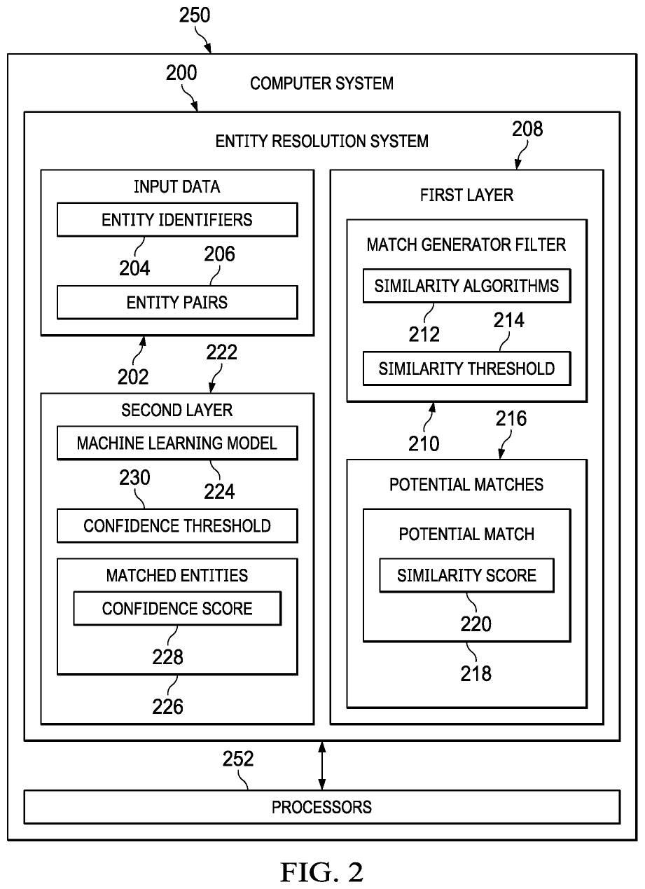

FIG. 2 is a block diagram of an entity resolution system depicted in accordance with an illustrative embodiment. Entity resolution system 200 might be implemented in network data processing system 100 in FIG. 1.

Entity resolution system 200 comprises a first layer 208 and a second layer 224 that operate on input data 202. The first layer 208 filters out different companies that are clearly not the same entity. The second layer 224 performs a more refined comparison of similar company names.

Input data 202 comprises a number of entity identifiers 204 representing names and addresses of companies listed, e.g., in shipping records. Due to variations in the way names and addresses are entered into records, the same company may in fact be listed multiple times. For example, a legal designation within a company name may be either abbreviated or written out, e.g., Limited versus Ltd, Incorporated versus Inc., Corporation versus Corp., etc., or there might be a comma between the legal designation and the rest of the name versus no comma. There might be variations in the name due to simple typographical errors. Similarly, there might be multiple listings for the same company due to variations in how the address is written, e.g., Lane versus Ln., Street versus St., Boulevard versus Blvd., North versus N, East versus E, etc., as well as, again, typographical errors.

Such variations in the entry of the name and address of the same company may be the result of entries made by parties at different locations and times within a supply chain. Of course, many of the entity identifiers 204 may be for completely different companies. It is the job of the entity resolution system 200 to make that determination.

To make this determination, entity identifiers 204 are grouped into entity pairs 206 that can be compared with each other.

First layer 208 comprises match generator filter 210, which filters the entity pairs 206 for potential matches 216. Match generator filter 210 employs a number of similarity algorithms 212 which evaluate the entity identifiers comprising each of entity pair 206.

Each potential match 218 among potential matches 216 has a similarity score 220. Potential matches 216 comprises entity pairs 206 with a similarity score 220 above a specified similarity threshold 214.

Second layer 222 comprises a machine learning model 224 that determines which of potential matches 216 are in fact matched entities 226, wherein both entity identifiers in an entity pair refer to the same company, e.g., ABC Incorporated and ABC, Inc. Each pair of matched entities 226 has an associated confidence score 228 (e.g., 0.9 or 90%) generated by the machine learning model 224 above a specified confidence threshold 230.

Entity resolution system 200 can be implemented in software, hardware, firmware, or a combination thereof. When software is used, the operations performed by entity resolution system 200 can be implemented in program code configured to run on hardware, such as a processor unit. When firmware is used, the operations performed by entity resolution system 200 can be implemented in program code and data and stored in persistent memory to run on a processor unit. When hardware is employed, the hardware may include circuits that operate to perform the operations in entity resolution system 200.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

These components for entity resolution system 200 can be located in computer system 250, which is a physical hardware system and includes one or more data processing systems. When more than one data processing system is present in computer system 250, those data processing systems are in communication with each other using a communications medium. The communications medium can be a network. The data processing systems can be selected from at least one of a computer, a server computer, a tablet computer, or some other suitable data processing system.

For example, entity resolution system 200 can run on one or more processors 252 in computer system 250. As used herein a processor unit is a hardware device and is comprised of hardware circuits such as those on an integrated circuit that respond and process instructions and program code that operate a computer. When one or more processors 252 execute instructions for a process, one or more processors 252 that can be on the same computer or on different computers in computer system 250. In other words, the process can be distributed between processors 252 on the same or different computers in computer system 250. Further, one or more processors 252 can be of the same type or different type of processors 252. For example, one or more processors 252 can be selected from at least one of a single core processor, a dual-core processor, a multi-processor core, a general-purpose central processing unit (CPU), a graphics processing unit (GPU), a digital signal processor (DSP), or some other type of processor.

There are three main categories of machine learning: supervised, unsupervised, and reinforcement learning. Supervised machine learning comprises providing the machine with training data and the correct output value of the data. During supervised learning the values for the output are provided along with the training data (labeled dataset) for the model building process. The algorithm, through trial and error, deciphers the patterns that exist between the input training data and the known output values to create a model that can reproduce the same underlying rules with new data. Examples of supervised learning algorithms include regression analysis, decision trees, k-nearest neighbors, neural networks, and support vector machines.

If unsupervised learning is used, not all of the variables and data patterns are labeled, forcing the machine to discover hidden patterns and create labels on its own through the use of unsupervised learning algorithms. Unsupervised learning has the advantage of discovering patterns in the data with no need for labeled datasets. Examples of algorithms used in unsupervised machine learning include k-means clustering, association analysis, and descending clustering.

Whereas supervised and unsupervised methods learn from a dataset, reinforcement learning methods learn from feedback to re-learn/retrain the models. Algorithms are used to train the predictive model through interacting with the environment using measurable performance criteria.

Machine learning model 226 may comprise, e.g., a random forest algorithm trained via supervised learning.

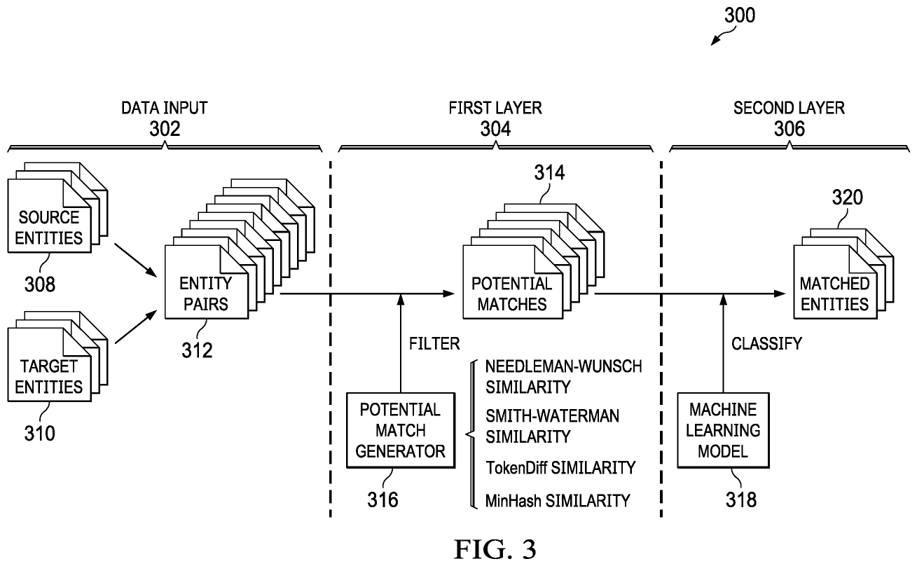

FIG. 3 depicts a diagram illustrating the operation of the entity resolution system 200 in accordance with an illustrative embodiment. Process 300 comprises three main stages: data input 302, filtering by first layer 304, and classification by the second layer 306.

Data input 302 is performed in batches at regular intervals such as every day, week, or month. Source entities 308 comprise new data batches that have not yet been processed. Target entities 310 comprise previous data batches that have already been processed. The entities are then organized into entity pairs 312. Because target entities 310 have been previously processed, process 300 proceeds faster if target entities 310 are not paired with each other. Therefore, in an illustrative embodiment, source entities 308 are paired with each other and paired with target entities 310 in entities pairs 312.

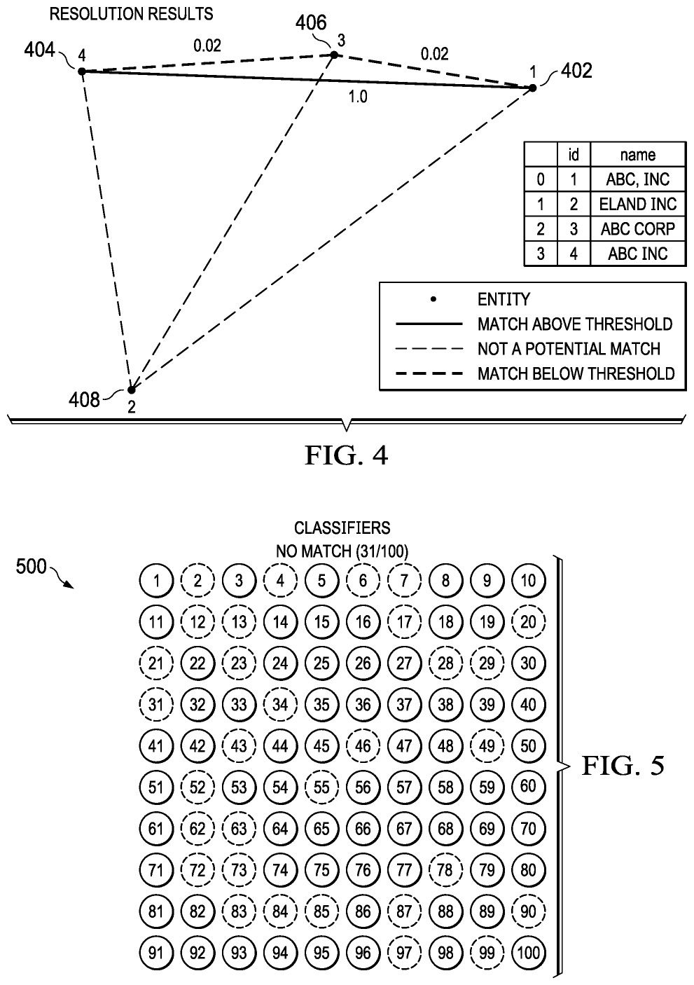

The entity pairs 312 are passed to the first layer 304, where potential match generator 316 filters potential matches 314. The filtering is accomplished by comparing the constituent entities of each pair to each other using a number of similarity algorithms. Examples of the similarity algorithms that may be used include Needleman-Wunsch, Smith-Waterman, Token Diff, and MinHash. The similarity between members of an entity pair can be represented as a distance between points (see FIG. 4). Potential matches 314 include entity pairs that have a similarity score above a specified threshold. This threshold may vary depending on the dataset in question and user needs.

After potential matches 314 have been identified among the entity pairs 312, these potential matches pass to the second layer 306, where a machine learning model 318 performs a more refined comparison of the entities in each pair of potential matches 314. Machine learning model 318 may comprise, e.g., a random forest model, which determines if the constituent entities in each pair refer to the same company. If the entities constituting a pair do in fact refer to the same company, machine learning model 318 classifies those entities as matched entities 320.

FIG. 4 depicts a diagram illustrating resolutions results between entity identifiers in accordance with an illustrative embodiment. FIG. 4 illustrates the relative similarity between four different entity identifiers and is an example of identifying both potential matches and matched entities by the potential match generator 316 and machine learning model 318, respectively, in FIG. 3.

In the illustrated example, four entity identifiers are depicted for ease of illustration. However, it should be understood that typically many more entities would be evaluated at once. Each node 402, 404, 406, 408 (representing entity identifiers) has a relative distance from the others depending on the degree of similarity between them. The greater the distance, the more dissimilar the entity identifiers in question are.

In the present example, the matcher generator filter is able to identify nodes 402 (ABC, INC), 404 (ABC INC), and 406 (ABC CORP) as potential matches because the distances between them correspond to respective similarity scores above the specified similarity threshold. The potential match generator is also able to eliminate node 408 (ELAND INC) as a potential match because its distance from the other nodes is too great, and thus its respective similarity scores relative to each of the other nodes is below the specified similarity threshold. Therefore, entity resolution system would pass along entity pairs 402/404, 402/406, and 404/406 to the machine learning model as potential matches.

When the machine learning model evaluates potential matches 402/404, 402/406, and 404/406, it generates confidence scores for each potential match. In the present example, potential match 402/404 has a confidence score of 1.0 (100%), indicating that ABC, INC and ABC INC are the same company (the comma notwithstanding). However, potential matches 402/406 and 404/406 both have a confidence score of 0.2, which in the present example is below the specified confidence threshold, indicating that ABC CORP is not the same company as ABC INC and ABC, INC.

FIG. 5 depicts a diagram illustrating a visualization of forest view of a random forest model in accordance with an illustrative embodiment. Random forest 500 may be an example of machine learning model 224, 318. The present example included 100 trees. Of those 100 trees, 31 indicate a match between two entity identifiers, and 69 indicate no match. Assuming a default threshold of 0.5 (50/100), random forest 500 in the present example indicates there is no match between the entity pair in question.

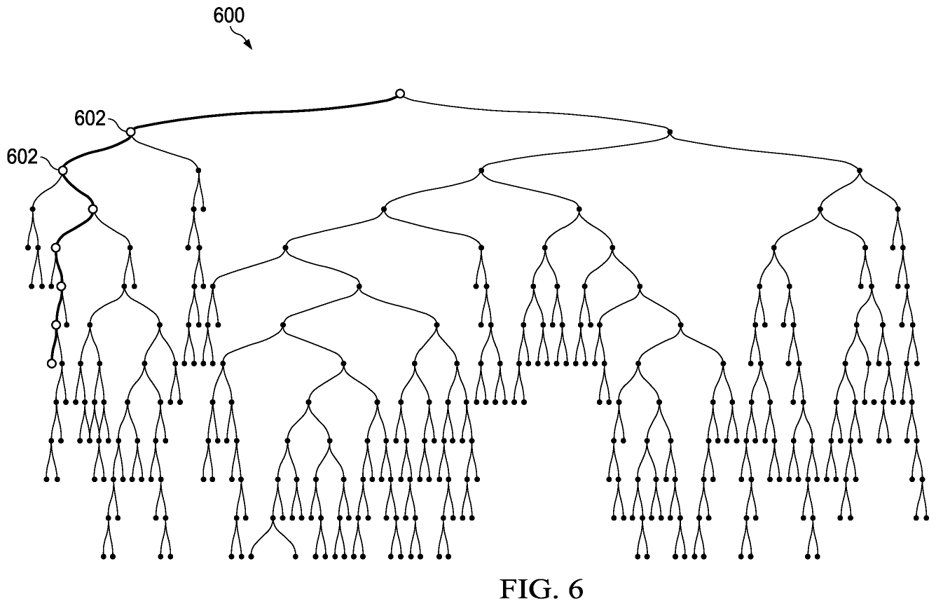

FIG. 6 depicts a diagram illustrating a visualization of a tree view of a random forest model in accordance with an illustrative embodiment. Tree view 600 illustrates the path the random forest model takes to classify an entity pair, as indicated by white nodes 602.

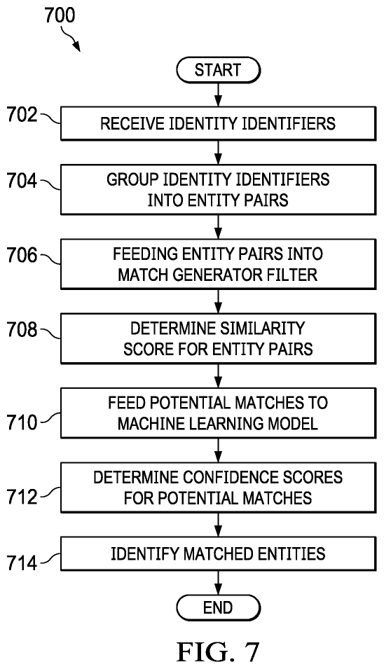

FIG. 7 depicts a flowchart illustrating a process for entity resolution in accordance with an illustrative embodiment. Process 700 can be implemented in hardware, software, or both. When implemented in software, the process can take the form of program code that is run by one of more processor units located in one or more hardware devices in one or more computer systems. Process 700 might be implemented in entity resolution system 200 in FIG. 2.

Process 700 begins by receiving a number of different entity identifiers (step 702). The entity identifiers may comprise source entities and target entities. Each entity identifiers may comprise a name and address. The entity identifiers may differ from each other according to differences in entry of at least one of name or address.

The entity identifiers are then grouped into a number of entity pairs (step 704).

The entity pairs are fed into a match generator filter (step 706). The match generator filter determines a similarity score for each entity pair according to a number of similarity algorithms (step 708). The similarity algorithms may comprise, e.g., Needleman-Wunsch similarity, Smith-Waterman similarity, Token Diff similarity, or MinHash similarity.

Potentially matching entity pairs are then fed into a machine learning model, wherein the potentially matching entity pairs comprise a subset of entity pairs having similarity scores above a first specified similarity threshold (step 710).

The machine learning model determines a confidence score for each potentially matching entity pair (step 712). The machine learning model may comprise a random forest model and may be trained through supervised learning.

The machine learning model then identifies matched entities, wherein the matched entities comprise a subset of potentially matching entity pairs having confidence scores above a second specified confidence threshold (step 714).

The machine learning model identifies matched entity pairs from the potentially matching entity pairs with entity identifiers that refer to the same entity (step 714).

Process 700 then ends.

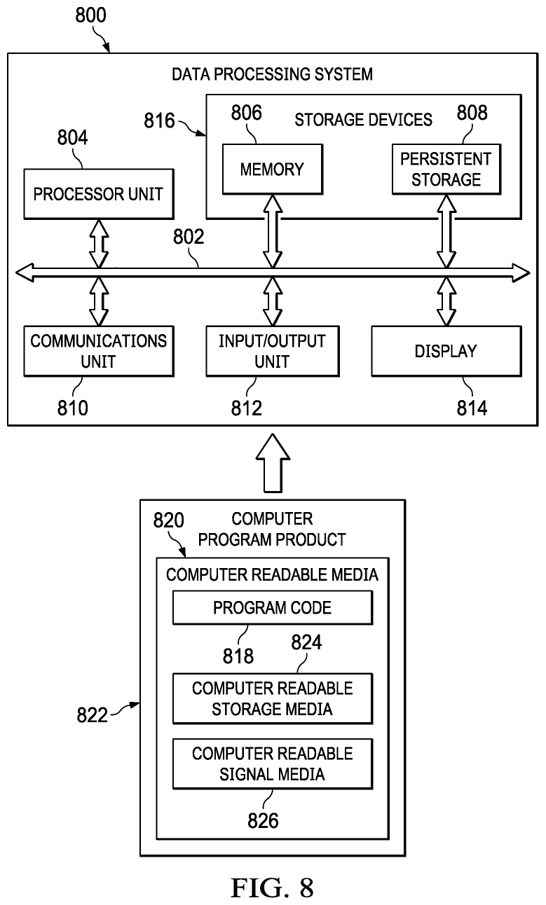

Turning now to FIG. 8, an illustration of a block diagram of a data processing system is depicted in accordance with an illustrative embodiment. Data processing system 800 may be used to implement server computers 104 and 106 and client devices 110 in FIG. 1, as well as computer system 250 in FIG. 2. In this illustrative example, data processing system 800 includes communications framework 802, which provides communications between processor unit 804, memory 806, persistent storage 808, communications unit 810, input/output unit 812, and display 814. In this example, communications framework 802 may take the form of a bus system.

Processor unit 804 serves to execute instructions for software that may be loaded into memory 806. Processor unit 804 may be a number of processors, a multi-processor core, or some other type of processor, depending on the particular implementation. In an embodiment, processor unit 804 comprises one or more conventional general-purpose central processing units (CPUs). In an alternate embodiment, processor unit 804 comprises one or more graphical processing units (CPUs).

Memory 806 and persistent storage 808 are examples of storage devices 816. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 816 may also be referred to as computer-readable storage devices in these illustrative examples. Memory 806, in these examples, may be, for example, a random access memory or any other suitable volatile or non-volatile storage device. Persistent storage 808 may take various forms, depending on the particular implementation.

For example, persistent storage 808 may contain one or more components or devices. For example, persistent storage 808 may be a hard drive, a flash memory, a rewritable optical disk, a rewritable magnetic tape, or some combination of the above. The media used by persistent storage 808 also may be removable. For example, a removable hard drive may be used for persistent storage 808. Communications unit 810, in these illustrative examples, provides for communications with other data processing systems or devices. In these illustrative examples, communications unit 810 is a network interface card.

Input/output unit 812 allows for input and output of data with other devices that may be connected to data processing system 800. For example, input/output unit 812 may provide a connection for user input through at least one of a keyboard, a mouse, or some other suitable input device. Further, input/output unit 812 may send output to a printer. Display 814 provides a mechanism to display information to a user.

Instructions for at least one of the operating system, applications, or programs may be located in storage devices 816, which are in communication with processor unit 804 through communications framework 802. The processes of the different embodiments may be performed by processor unit 804 using computer-implemented instructions, which may be located in a memory, such as memory 806.

These instructions are referred to as program code, computer-usable program code, or computer-readable program code that may be read and executed by a processor in processor unit 804. The program code in the different embodiments may be embodied on different physical or computer-readable storage media, such as memory 806 or persistent storage 808.

Program code 818 is located in a functional form on computer-readable media 820 that is selectively removable and may be loaded onto or transferred to data processing system 800 for execution by processor unit 804. Program code 818 and computer-readable media 820 form computer program product 822 in these illustrative examples. In one example, computer-readable media 820 may be computer-readable storage media 824 or computer-readable signal media 826.

In these illustrative examples, computer-readable storage media 824 is a physical or tangible storage device used to store program code 818 rather than a medium that propagates or transmits program code 818. Computer readable storage media 824, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 818 may be transferred to data processing system 800 using computer-readable signal media 826. Computer-readable signal media 826 may be, for example, a propagated data signal containing program code 818. For example, computer-readable signal media 826 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 800 are not meant to provide architectural limitations to the manner in which different embodiments may be implemented. The different illustrative embodiments may be implemented in a data processing system including components in addition to or in place of those illustrated for data processing system 800. Other components shown in FIG. 8 can be varied from the illustrative examples shown. The different embodiments may be implemented using any hardware device or system capable of running program code 818.

As used herein, “a number of,” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method for entity resolution, the method comprising:
using a number of processors to perform the steps of:
receiving a number of different entity identifiers;
grouping the entity identifiers into a number of entity pairs;
feeding the entity pairs into a match generator filter;
determining, by the match generator filter, according to a number of similarity algorithms, a similarity score for each entity pair;
feeding potentially matching entity pairs into a machine learning model, wherein the potentially matching entity pairs comprise a subset of the entity pairs that have similarity scores above a first specified threshold;
determining, by the machine learning model, a confidence score for each potentially matching entity pair; and
identifying, by the machine learning model, matched entities, wherein the matched entities comprise a subset of the potentially matching entity pairs that have confidence scores above a second specified threshold.

2. The method of claim 1, wherein the entity identifiers comprise source entities and target entities, wherein source entities comprise new data records, wherein and target entities comprise previously processed data records.

3. The method of claim 2, wherein target entities are not paired with each other.

4. The method of claim 1, wherein each entity identifier comprises a name and address of a company.

5. The method of claim 4, wherein the entity identifiers differ from each other according to differences in entry of at least one of name or address.

6. The method of claim 1, wherein the similarity algorithms comprise at least one of:
Needleman-Wunsch similarity;
Smith-Waterman similarity;
Token Diff similarity; or
MinHash similarity.

7. The method of claim 1, wherein the machine learning model comprises a random forest model.

8. The method of claim 1, wherein the machine learning model is trained with supervised learning.

9. A system for entity resolution, the system comprising:
a storage device configured to store program instructions; and
one or more processors operably connected to the storage device and configured to execute the program instructions to cause the system to:
receive a number of different entity identifiers;
group the entity identifiers into a number of entity pairs;
feed the entity pairs into a match generator filter;
determine, by the match generator filter, according to a number of similarity algorithms, a similarity score for each entity pair;
feed potentially matching entity pairs into a machine learning model, wherein the potentially matching entity pairs comprise a subset of the entity pairs that have similarity scores above a first specified threshold;
determine, by the machine learning model, a confidence score for each potentially matching entity pair; and
identify, by the machine learning model, matched entities, wherein the matched entities comprise a subset of the potentially matching entity pairs that have confidence scores above a second specified threshold.

10. The system of claim 9, wherein the entity identifiers comprise source entities and target entities, wherein source entities comprise new data records, wherein and target entities comprise previously processed data records.

11. The system of claim 10, wherein target entities are not paired with each other.

12. The system of claim 9, wherein each entity identifiers comprises a name and address of a company.

13. The system of claim 12, wherein the entity identifiers differ from each other according to differences in entry of at least one of name or address.

14. The system of claim 9, wherein the similarity algorithms comprise at least one of:
Needleman-Wunsch similarity;
Smith-Waterman similarity;
Token Diff similarity; or
MinHash similarity.

15. The system of claim 9, wherein the machine learning model comprises a random forest model.

16. The system of claim 9, wherein the machine learning model is trained with supervised learning.

17. A computer program product for entity resolution, the computer program product comprising:
a computer-readable storage medium having program instructions embodied thereon to perform the steps of:
receiving a number of different entity identifiers;
grouping the entity identifiers into a number of entity pairs;
feeding the entity pairs into a match generator filter;
determining, by the match generator filter, according to a number of similarity algorithms, a similarity score for each entity pair;
feeding potentially matching entity pairs into a machine learning model, wherein the potentially matching entity pairs comprise a subset of the entity pairs that have similarity scores above a first specified threshold;
determining, by the machine learning model, a confidence score for each potentially matching entity pair; and
identifying, by the machine learning model, matched entities, wherein the matched entities comprise a subset of the potentially matching entity pairs that have confidence scores above a second specified threshold.

18. The computer program product of claim 17, wherein the entity identifiers comprise source entities and target entities, wherein source entities comprise new data records, wherein and target entities comprise previously processed data records.

19. The computer program product of claim 18, wherein target entities are not paired with each other.

20. The computer program product of claim 17, wherein each entity identifiers comprises a name and address of a company.

21. The computer program product of claim 19, wherein the entity identifiers differ from each other according to differences in entry of at least one of name or address.

22. The computer program product of claim 17, wherein the similarity algorithms comprise at least one of:
Needleman-Wunsch similarity;
Smith-Waterman similarity;
Token Diff similarity; or
MinHash similarity.

23. The computer program product of claim 17, wherein the machine learning model comprises a random forest model.

24. The computer program product of claim 17, wherein the machine learning model is trained with supervised learning.

25. A computer-implemented method for entity resolution, the method comprising:
using a number of processors to perform the steps of:
receiving a number of different entity identifiers comprising names and addresses of companies in shipping records;
grouping the entity identifiers into a number of entity pairs;
identifying, from among the entity pairs, a number of potential matches according to a number of similarity algorithms, wherein potential matches have a similarity score above a specified similarity threshold; and
identifying, by a random forest model, a number of matched entities from among the potential matches, wherein the matched entities have confidence scores above a specified confidence threshold, and wherein the matched entities are pairs of entity identifiers that refer to the same company.
